(19) United States
(12) Patent Application Publication
(10) Pub. No.: US 2006/0143874 A1
(43) Pub. Date: Jul. 6, 2006

(54) Stylus clip implement

(76) Inventor: Carl Cetera, Tenafly, NJ (US)

Correspondence Address: THE SONI LAW FIRM, 55 S. LAKE AVE SUITE 720, PASADENA, CA, 91101, US

(21) Appl. No.: 11/127,684

(22) Filed: May 11, 2005

Related U.S. Application Data
(60) Provisional application No. 60/640,761, filed on Dec. 30, 2004.

(51) Int. Cl. B43K 25/00

(52) U.S. Cl. 24/10 R

(57) ABSTRACT

A multifunction stylus tip hand held implement includes a combination device of a pocket clip and a stylus. The stylus may be stored in a recessed cavity in the clip. The stylus rotates up from the clip into a position where the stylus is available for use on a PDA. When not in use, the stylus is securely stowed in the recessed cavity. The combination device may be placed on any elongated handheld instrument. An advantage of the clip is that it allows the user to readily switch back and forth between writing with a ball point pen tip and writing with the stylus.

### CLAIM OF PRIORITY

This application claims priority to provisional application No. 60/640,761, filed on Dec. 30, 2004, and should be considered a conversion of same to a non-provisional application.

### BACKGROUND OF THE INVENTION

1. Field of the Invention

The present invention relates to a multifunction handheld writing instrument. More specifically, the present invention relates to a handheld writing instrument that includes a combination of pocket clip, and stylus for use as an input device for a personal data assistant.

2. Description of the Prior Art

A variety of combination writing instruments are well known in the prior art. U.S. Pat. No. 4,129,925 to Brown describes a combined nail file and writing instrument clip attachment. U.S. Pat. No. 5,090,427 to Sherts discloses a combination finger groomer attachment that performs a variety of manicure operations, and writing instrument clip on a pen cap.

U.S. Pat. No. 6,076,986 to Manno, a continuation in part of U.S. Pat. No. 5,865,552 to Manno, discloses an assembly of a writing instrument and a tooth pick. The pick is pivotably attached by a hinge to the writing instrument clip. The hinge enables the pick to move between a first position where the pick is disposed in a slot in the spring clip and a second position where the pick extends outward from the slot. The pick comprises a generally conically shaped body made of a polymeric material that is unlikely to injure the gums of a user and terminates in a point.

Writing instruments incorporating both a stylus tip and a ball point pen have also been described. Hazzard, in U.S. Pat. Nos. 5,913,629; 6,050,735; D402,690; and D424,112 disclose writing instruments with a ball point pen tip capable of projecting out from under a fixed stylus tip when the ball point mechanism is actuated. Hazzard does not, however, describe a stylus tip as part of a clip assembly.

A combination of a stylus tip and a pocket clip mounted on the cap of a writing instrument is described by Haffner in U.S. Pat. No. 6,659,673. In that invention, there is a slidable member functioning as a pocket clip on one end and as a stylus on the other end. The disadvantage of this device is that the end of the writing instrument closest to the clip attachment must be tapered in order to allow the stylus to extend out past the pen body. Furthermore, as the combination stylus and clip is mounted on a pen cap, the cap must be removed to get access to the ball point pen tip. In addition, the cap can be lost or misplaced. Finally, the pocket clip end is pointed, narrow, and fragile.

What is needed is a combination stylus and pocket clip that can be used on any elongated instrument. Such a combination would allow the user to readily switch back and forth from writing with a ball point tip to using the stylus without the necessity of actuating the ball point pen writing mechanism nor removing the pen cap.

### SUMMARY OF THE INVENTION

It is accordingly an object of the present invention to provide a combination device comprising a clip and a PDA stylus, wherein said device may be used with an elongated writing instrument.

Another object of the present invention is to provide a combination device comprising a clip and a PDA stylus, wherein said clip is broad and sturdy.

Still another object of this invention is to provide a combination device comprising a clip and a PDA stylus, wherein said PDA device could be placed on a part of a writing instrument other than the cap.

It is yet another object of the present invention to provide a combination device comprising a clip and a PDA stylus, wherein said stylus can be easily deployed from the pen or securely stored within the clip.

The objects of this invention are accomplished by providing a combination device comprising a clip and a PDA stylus wherein the stylus folds out from it's attachment to the pen clip. The stylus has a blunt end rotatably connected with the clip and a pointed end that swings out to write on a PDA. The stylus can thus swing freely from a closed, wherein it lays against the clip, to an extended writing position. The stylus may be stored within a recess in the clip when the stylus is not in use. This help prevent breakage of the stylus and keeps the stylus from snagging on clothing.

The advantage of the combination clip and stylus of the present invention is that the ball point pen can be used with the stylus in either it's extended or stowed position. The way that the stylus folds out from the clip allows the combination device to be placed upon any elongated instrument. The device could be placed anywhere on an elongated writing instrument and is thus not restricted to just the cap. Furthermore, the upper end of the writing instrument need not be tapered in order allow the stylus to be deployed and extend out past the upper end of the writing instrument.

The presently described device of a clip and a stylus of the present invention is comprised of a clip member having a first end and a second end and a stylus having a blunt end and a pointed end with a trans-axially aligned guide pin pivotally engaging the blunt end of the stylus with the first end of the clip member wherein the stylus is rotatably connected to, and may in an extended position rotate out superior to, the first end of said clip member.

Still other objects and advantages of the present invention will become readily apparent to those skilled in the art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

The foregoing objects, features, advantages and preferred embodiments of the evacuation unit and method of the present invention will be better understood from the following detailed description taken in conjunction with the accompanying drawings in which:

FIG. 1 is a perspective view of the preferred embodiment of the present invention in the configuration of a writing implement which shows the stylus point of the clip in its closed position whereby the stylus is biased against the backing plate portion of the clip.

FIG. 2 is a front view of the preferred embodiment of the present invention in the configuration of a writing implement which shows the stylus point of the clip in its closed position whereby the stylus is biased against the backing plate portion of the clip.

FIG. 3 is a side view of the preferred embodiment of the present invention in the configuration of a writing implement which shows the stylus point of the clip in its closed position whereby the stylus is biased against the backing plate portion of the clip and depicts the pivoting pin about which the stylus point may rotate to open and close for use and storage, respectively.

FIG. 4 is a perspective view of the preferred embodiment of the present invention in the configuration of a writing implement which shows the stylus point of the clip in its open or extended position whereby the stylus point is extended axially beyond the tip of the implement.

FIG. 5 is a top view of a perspective view of the preferred embodiment of the present invention in the configuration of a writing implement which shows the stylus point of the clip in its closed position whereby the stylus is biased against the backing plate portion of the clip.

### DETAILED DESCRIPTION OF THE PREFERRED EMBODIMENT OF THE INVENTION

The accompanying Figures depict embodiments of the present invention, and features and components thereof. With regard to means for fastening, mounting, attaching or connecting the components of the present invention to form the apparatus as a whole, unless specifically described otherwise, such means are intended to at least encompass conventional fasteners such as machine screws, machine threads, snap rings, hose clamps such as screw clamps and the like, rivets, nuts and bolts, toggles, pins and the like. Components may also be connected by friction fitting, snap fitting, adhesives, or by welding or deformation, if appropriate. Unless specifically otherwise disclosed or taught, materials for making components of the present invention are selected from appropriate materials such as metal, metallic alloys, natural or synthetic fibers, plastics and the like, and appropriate manufacturing or production methods including casting, extruding, molding and machining may be used.

Any references to front and back, right and left, top and bottom, upper and lower, and horizontal and vertical are intended for convenience of description, not to limit the present invention or its components to any one positional or spacial orientation.

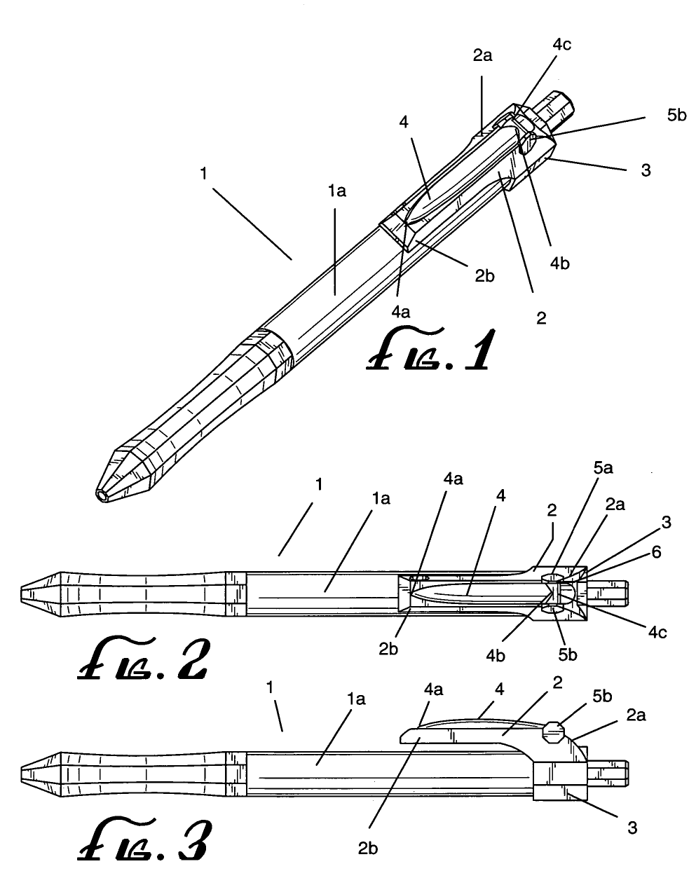

Referring more specifically to the drawings, there is shown in FIG. 1 an embodiment of the stylus tip hand held implement 1 in the configuration of a writing implement. The implement includes a main body 1a and the clip 2 which is attached to the main body. Each of the main body 1a and clip 2 can be fabricated from a variety of materials, such as a moldable polymer or of a metallic composition, depending on the desired cost and uses. While the preferred embodiment shown in FIGS. 1 to 5 depicts the clip 2 as being rigidly attached to the body 1a by means of a collar 3, the clip 2 may be attached by any feasible means and it also may be attached to the body 1a by a releasable means such that the clip 2 may be attached and alternatively detached, so as to be usable as a stylus piece, separate from the main body 1a of the implement 1. The clip 2 resembles a standard clip often used with a writing implement, however, the clip 2 of the present invention further includes a stylus 4 which is rotatably attached to the clip 2 such that it may be deployed by rotating the stylus 4 about the implement body 1a to facilitate the stylus 4 point extension axially outward from and beyond the end of the hand held implement 1.

As seen in FIGS. 2 through 5, the clip 2 has a first end 2a and a second end 2b. The first end 2a attaches to the elongated writing instrument implement body 1a in any of various ways well known in the art. There is a gap between the second end 2b of the clip 2 and the elongated instrument body 1a, whereby the elongated implement 1 may be placed inside a pocket, for example, with the second end 2b of the clip 2 placed outside the pocket, thus holding the instrument firmly in place.

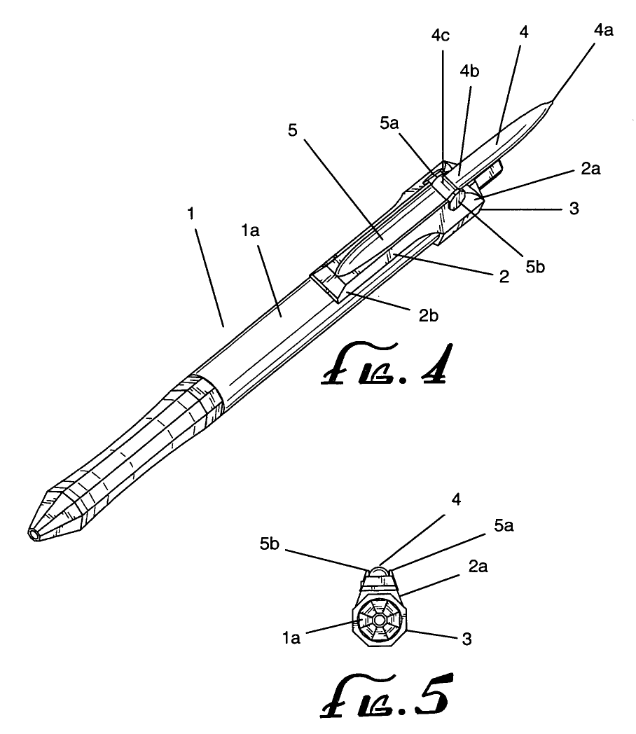

The stylus 4 is rotatably attached to the clip 2 so as to be used in an open or extended configuration or stored on a closed position. As shown in FIGS. 1 and 3, when not in use, the stylus 4 may be rotated down so that it lays flush against the clip 2. In the preferred embodiment, the clip 2 further comprises a recessed storage compartment 5, as shown in FIG. 4. This compartment 5 is a generally rectangular closed channel into which items may be stowed, such as extra lead, if appropriate. The compartment 5, having an upwardly facing opening, is ideally suited for locating the stylus 4 within the opening of the compartment 5 and the opening is shaped to accommodate the stylus 4. When the stylus 4 is not in use, it lays flat against, or in some embodiments such as the preferred embodiment drops into, this storage compartment 5. The pointed end 4a of the stylus 4 is thereby covered or shielded, and protected by being in this recessed position. This also helps protect the stylus 4 from snagging or causing damage to clothing articles.

The stylus 4 has a blunt end 4b and a pointed end 4a. In the preferred embodiment, at the blunt end 4b of the stylus 4 there is a generally cylindrical barrel 4c, aligned perpendicular to the vertical axis of the stylus 3, through which a guide pin 6 passes. The guide pin 6 also passes through axially aligned holes 5a and 5b in the sidewalls of the recessed storage compartment 5. The blunt end 4b of the stylus 4 is thus rotatably connected to the clip 2. Those skilled in the art will readily recognize other ways to rotatably connect the stylus with the clip member. Although in the preferred embodiment the stylus 4 rotates out in a plane that is aligned with the main vertical axis of the elongated implement 1, it should also be understood that the stylus 4 could just as effectively be rotated out in alternative planes.

The present invention may be embodied in other specific forms without departing from the essential spirit or attributes thereof. It is desired that the embodiments described herein be considered in all respects as illustrative, not restrictive, and that reference be made to the appended claims for determining the scope of the invention.

What is claimed is:

1. An elongated handheld implement comprising:
a main body;
a clip parallelly attached to said main body, said clip having a first end and a second end and configured such that a gap is formed between the second end of said clip and said main body; and
a PDA stylus fabricated from inflexible material said stylus having a blunt end and a pointed end, the first end of said clip pivotally engaging the blunt end of said stylus by a rotational connection member such that said stylus is rotatable in multiple planes, pivoted by said rotational connection member whereby the pointed end of said stylus is extendable axially outward beyond the first end of said clip for use in a PDA device.

2. (canceled)

3. The implement of claim 1, wherein said hand-held implement is selected from the group consisting of a writing instrument, a laser pointer, a stylus pen, a multi-function writing instrument, a screw driver, and a tire pressure gauge.

4. The implement of claim 1, wherein said clip defines a recessed storage compartment thereon along a longitudinal axis of said clip whereby said stylus is engageable with the side walls of said recessed storage compartment.

5. (canceled)

6. The implement of claim 1 whereby the clip is rigidly attached to the implement body.

7. The implement of claim 1 whereby the clip is detachable from the implement body so as to be utilized as a stylus point tool separate from the implement.

8. The implement of claim 1, wherein advertising or graphical material is imprinted on at least one outer surface of the implement for the purpose of advertising or promotion.

9. (canceled)

10. A clip comprising
a clip body having a first end and a second end; and
a PDA stylus fabricated from inflexible material said stylus having a blunt end and a pointed end, the first end of said clip body pivotally engaging the blunt end of said stylus by means of a rotational connection member, such that said stylus is rotatable in multiple planes pivoted by said rotational connection member whereby the pointed end of said stylus is extendable axially outward beyond the first end of said clip body for use in a PDA device.

11. The clip of claim 10, wherein said clip body defines a recessed storage compartment thereon along a longitudinal axis of said clip body whereby said stylus is engageable with the side walls of said recessed storage compartment.

12.-14. (canceled)

15. A method of advertising or promotion comprising the step of imprinting advertising or graphical material on at least one outer surface of an elongated handheld implement, said handheld implement comprising: a main body a clip; said clip having a first end and a second end; and a PDA stylus fabricated from inflexible material, said stylus having a blunt end and a pointed end, the first end of said clip pivotally engaging the blunt end of said stylus by means of a rotational connection member such that said stylus is rotatable in multiple planes, pivoted by said rotational connection member, whereby the pointed end of said stylus is extendable axially outward beyond the first end of said clip for use in a PDA device.

16. An elongated handheld implement comprising:
a main body having a longitudinal body axis;
a clip having a first end, a second end, and a longitudinal clip axis connecting the first and second ends, said clip being attached to said main body such that the clip axis is parallel to the body axis, said clip being configured such that a gap is formed between the second end of said clip and said main body; and
a PDA stylus fabricated from inflexible material, said stylus having a blunt end and a pointed end, the first end of said clip pivotally engaging the blunt end of said stylus by a rotational connection member such that said stylus is rotatable, pivoted by said rotational connection member, only in the plane defined by the parallel clip axis and the body axis whereby the pointed end of said stylus is extendable axially outward beyond the first end of said clip for use in a PDA device.

17. The implement claim 16, wherein said clip defines a recessed storage compartment thereon along the clip axis whereby said stylus is engageable with the side walls of said recessed storage compartment.

18. The implement of claim 17, wherein said rotational connection member further comprises a guide pin, and each of the blunt end of said stylus and the side walls of said recessed storage compartment further defines a hole thereon such that each of the holes is axially aligned with one another through which said guide pin passes.

19. The implement of claim 18, wherein said rotational connection member further comprises a cylindrical barrel aligned perpendicular to the longitudinal clip axis, through which said guide pin passes.

20. The implement of claim 16 whereby said clip is rigidly attached to said main body of the implement.

21. The implement of claim 16 whereby said clip is detachable from said main body of the implement so as to be utilized as a PDA stylus point tool separate from the implement.

22. The implement of claim 16, wherein advertising or graphical material is imprinted on at least one outer surface of the implement for advertising or promotion.
